(19) United States
(12) Patent Application Publication
(10) Pub. No.: US 2003/0186039 A1
(43) Pub. Date: Oct. 2, 2003

(54) Foamed polypropylene resin sheet

(75) Inventors: Satoshi Hanada, Ichihara-shi (JP); Hiroaki Takahata, Ichihara-shi (JP); Ryuma Kuroda, Ichihara-shi (JP)

Correspondence Address: Kendrew H. Colton, FITCH, EVEN, TABIN & FLANNERY, Suite 401L, 1801 K Street, N.W., Washington, DC, 20006-1201, US

(73) Assignee: Sumitomo Chemical Company, Limited, Osaka (JP)

(21) Appl. No.: 10/352,177

(22) Filed: Jan. 28, 2003

(30) Foreign Application Priority Data
Feb. 1, 2002 (JP) 2002-026036

(51) Int. Cl. B32B 3/26

(52) U.S. Cl. 428/304.4

(57) ABSTRACT

Disclosed is a foamed polypropylene resin sheet having a foamed layer comprising a resin material containing a polypropylene resin, wherein the foamed polypropylene resin sheet has a non-foamed layer satisfying the following requirements (i) and (ii):

(i) comprising a resin composition which contains a polypropylene resin and a filler and has a melt tension within the range of from 1 to 20 g, and

(ii) constituting one surface of the foamed polypropylene resin sheet,

wherein the ratio of the basis weight of the foamed layer to the basis weight of the non-foamed layer falls within the range of from 100:1 to 100:100. This foamed sheet is superior in light-weight property and rigidity and also superior in thermoformability.

### BACKGROUND OF THE INVENTION

1. Field of the Invention

The present invention relates to a foamed polypropylene resin sheet excellent in light-weight property and rigidity and also in thermoformability.

2. Description of the Related Art

Foamed polypropylene resin materials are superior in heat insulation property and light-weight property and therefore are used, for example, as packaging containers, materials for automobiles and materials for building or construction. In particular, foamed polypropylene resin sheets (henceforth, referred to as foamed sheets) obtained by forming foamed polypropylene resin materials into a sheet form are used widely.

In various applications such as those mentioned above, when a foamed sheet is required to further have a rigidity, a foamed sheet is used in which a filler such as talc is incorporated in a resin material containing a polypropylene resin. In addition, when the filler is incorporated only in a non-foamed layer to form a multilayer foamed sheet in which a foamed layer and the non-foamed layer are laminated together, a foamed sheet can be obtained which is superior in light-weight property, heat insulation property and rigidity. An example of applications of such a foamed sheet is disclosed in a gazette of Japanese Utility Model No. 2605351. In this gazette, disclosed is an office file formed of a laminate sheet comprising a polyolefin resin foamed layer and a polyolefin resin non-foamed layer containing a filler in an amount of from 10 to 400 parts by weight based on 100 parts by weight of a resin.

Moreover, when the aforementioned foamed sheet is used in the above-mentioned application, the foamed sheet is often formed by thermoforming. For example, when the above-mentioned foamed sheet is used as a container for foodstuff, products obtained by forming a foamed sheet into a shape of cup, tray, glass, box or the like by thermoforming are used widely.

However, when foamed sheets constituted of a foamed layer and a non-foamed layer containing a filler are formed into containers with various shapes such as cup and tray by thermoforming (vacuum forming, pressure forming, vacuum pressure forming, and the like), a problem in that the foamed sheet forms a large sagging (draw-down) at the time of heating the foamed sheet may arise.

In order to thermoform the foamed sheet, it is generally necessary to fix the edge of the foamed sheet and soften the foamed sheet by heating. However, a foamed sheet heated may hang down in its central area. If the degree of the draw-down is too great, large wrinkles may be formed in an article formed from the foamed sheet. Moreover, the sagging portion may come into contact with a heater for heating, resulting in melting or burning.

On the other hand, if a foamed sheet is not heated too much for the purpose of prevention of draw-down, the forming of the foamed sheet may be achieved incompletely and an undesired shape may be obtained or a formed article obtained may be damaged.

Accordingly, foamed sheets which are controlled to form draw-down and are suitable for thermoforming are awaited.

### BRIEF SUMMARY OF THE INVENTION

After diligent investigations for solving the above-mentioned problems, the present inventors found that, in a foamed polypropylene resin sheet having a multilayer structure comprising a foamed layer and a non-foamed layer containing a filler, when a resin material constituting a surface non-foamed layer is let to have a melt tension within a specific range, a polypropylene resin foamed sheet can be obtained which will form little draw-down during its thermoforming and is excellent in formability.

For solving the above-mentioned problems, the foamed polypropylene resin sheet of the present invention is a foamed polypropylene resin sheet having a foamed layer comprising a resin material containing a polypropylene resin, wherein the foamed polypropylene resin sheet has a non-foamed layer satisfying the following requirements (i) and (ii):

(i) comprising a resin composition which contains a polypropylene resin and a filler and has a melt tension within the range of from 1 to 20 g, and

(ii) constituting one surface of the foamed polypropylene resin sheet,

wherein the ratio of the basis weight of the foamed layer to the basis weight of the non-foamed layer falls within the range of from 100:1 to 100:100.

According to the constitution mentioned above, since the resin composition constituting the non-foamed layer has a melt tension within the range of from 1 to 20 g, draw-down of a resulting foamed polypropylene resin sheet can be inhibited. Therefore, when producing a formed article using a foamed polypropylene resin sheet, it is possible to obtain a good appearance of the formed article because, for example, no wrinkles will be formed in a fringe of the formed article. Moreover, by letting the melt tension be within the range of from 1 to 20 g, the draw-down can be suppressed and therefore, at the time of production of a formed article by thermoforming (vacuum forming) a polypropylene resin foamed sheet, the foamed sheet is prevented from coming into contact with a heater for heating it due to its draw-down. This will prevent the foamed polypropylene resin sheet from being molten or burnt by the heater, making it possible to produce a formed article using the foamed polypropylene resin sheet.

The foamed polypropylene resin sheet of the present invention preferably has a constitution in which the non-foamed layer contains a filler in an amount within the range of from 40 to 100 parts by weight based on 100 parts by weight of the polypropylene resin contained in the resin composition.

The foamed polypropylene resin sheet of the present invention preferably has a constitution in which the resin composition constituting the non-foamed layer has a melt flow rate within the range of from 0.5 to 5 g/10 minutes.

Furthermore, the foamed polypropylene resin sheet of the present invention preferably has a constitution in which each of both surfaces of the foamed polypropylene resin sheet is a non-foamed layer satisfying the requirement (i).

According to the foregoing constitution, by letting both surfaces be the above-mentioned non-foamed layers satisfying the requirement (i), draw-down can be inhibited much more.

### DESCRIPTION OF THE DRAWINGS

In the drawings:

FIG. 1(a) through (d) are schematic views showing lamination states of foamed polypropylene resin sheets of the present invention;

FIG. 2 is a schematic perspective view illustrating the draw-down of a foamed polypropylene resin sheet;

FIG. 3 is a front view showing the outline of an apparatus for measuring the melt tension; and

FIG. 4 is a graph showing the melt tension measured.

### DESCRIPTION OF PREFERRED EMBODIMENTS

The polypropylene resin foamed sheet of the present invention is a foamed polypropylene resin sheet having a foamed layer comprising a resin material containing a polypropylene resin, wherein the foamed polypropylene resin sheet has a non-foamed layer satisfying the following requirements (i) and (ii):

(i) comprising a resin composition which contains a polypropylene resin and a filler and has a melt tension within the range of from 1 to 20 g, and

(ii) constituting one surface of the foamed polypropylene resin sheet,

wherein the ratio of the basis weight of the foamed layer to the basis weight of the non-foamed layer falls within the range of from 100:1 to 100:100.

In the following description, a non-foamed layer that satisfies the above-mentioned requirements (i) and (ii) is referred to as an “essential non-foamed layer.” In addition, the polypropylene resin that constitutes the foamed layer is called a first polypropylene resin, whereas the polypropylene resin that constitutes the essential non-foamed layer is called a second polypropylene resin, for convenience.

First, the foamed layer is explained. The foamed layer is a layer comprising a resin material containing at least one kind of the first polypropylene resin. The foamed layer is a layer the expansion ratio of which exceeds 1.5 times. The expansion ratio is preferably not less than twice and not more than 40 times, more preferably not less than three times and not more than 10 times. By setting the expansion ration within the above ranges, it is possible to obtain a polypropylene resin foamed sheet (henceforth, referred to as a foamed sheet) excellent in heat insulation property and strength. The expansion ratio of the foamed layer can be adjusted by suitably changing the amount of a foaming agent added and physical conditions during foamed sheet production such as forming.

As the foaming agent to be used for forming the foamed layer, any of so-called chemical foaming agents and physical foaming agents can be used. Specific examples of the chemical foaming agents include heat decomposition type foaming agents which generate nitrogen gas such as azodicarbonamide, azobisisobutyronitrile, dinitrosopentamethylenetetramine, p-toluenesulfonylhydrazide, and p,p′-oxy-bis (benzenesulfonyl hydrazide); heat decomposition type inorganic foaming agents which generate carbon dioxide gas such as sodium dicarbonate, ammonium carbonate and ammonium dicarbonate; and the like. Specific examples of the physical foaming agents include propane, butane, water, and carbon dioxide gas. Of the foaming agents listed above, water and carbon dioxide gas are suitably used since these are substances inert at high temperatures or inert to fire. In this embodiment, the amount of the foaming agent used is not critical and maybe suitably adjusted depending upon the kind of the foaming agent used and the kind of the resin used so that a desired expansion ratio is achieved.

Specific examples of the first polypropylene resin include propylene homopolymers and propylene-based copolymers containing not less than 50 mole % of propylene units.

In the polypropylene-based copolymers, examples of monomers copolymerizable with propylene include ethylene and α-olefins having from 4 to 10 carbon atoms. Specific examples of the α-olefins having from 4 to 10 carbon atoms include 1-butene, 4-methylpentene-1, 1-hexene and 1-octene. When of the mentioned-above α-olefins ethylene is used as a monomer copolymerizable with propylene, the content of ethylene units in the copolymer is preferably 10% by weight or less. When an α-olefin having from 4 to 10 carbon atoms is used as the monomer copolymerizable with propylene, the content thereof is preferably 30% by weight or less.

When using (1) a long-chain branched polypropylene resin and/or (2) a polypropylene resin having a weight average molecular weight of 1×10⁵ or more as the first polypropylene resin, it is possible to forma foam layer having a cell structure with a greater uniformity.

Of the polypropylene resins (1) and (2) mentioned above, particularly preferred is one such that the ratio of η₁ to η₁₀₀ (η₁₀₀/η₁) is 10 or more ((η₁₀₀/η₁≧10) wherein η₁ and η₁₀₀ represent, respectively, uniaxial melt elongational viscosities at the times 1 second and 100 seconds from the commencement of straining when a uniaxial melt elongational viscosity test is performed under measurement conditions: measuring temperature=(melting point+30° C.) and tensile strain rate=0.1 se⁻¹ using an apparatus such as a Meissener type elongational rheometer (e.g. Melten Rheometer manufactured by Toyo Seiki Seisaku-sho, Ltd.)

The long-chain branched polypropylene resin (1) includes polypropylene resins having a branch index [A] within the range of from 0.20 to 0.98, namely 0.20≦[A]≦0.98. Examples of the long-chain branched polypropylene resins include those having a structure of a propylene homopolymer or of a propylene copolymer obtained by polymerizing propylene with at least one kind of monomer selected from propylene, ethylene and olefins having from 4 to 10 carbon atoms. The propylene copolymer may be any of a block copolymer, a random copolymer and a graft copolymer.

A specific example of the polypropylene resins having a branch index [A] within the range of from 0.20 to 0.98 is a polypropylene available from Montell Technology Company by available as PF-814.

The above-mentioned branch index [A] indicated the degree of branching of long chains and is defined by the following equation:

Branch index [A]=[η]_{Br}/[η]_{Lin}

wherein [η]_{Br} indicates an intrinsic viscosity of the olefin-based resin having a long-chain branch and [η]_{Lin} indicates an intrinsic viscosity of a linear olefin-based resin having repeating units and weight average molecular weight the same as those the olefin-based resin having a long-chain branch has. When the intrinsic viscosity of a polypropylene resin is used as the above-mentioned [η]_{Br} and [η]_{Lin}, the branch index of the polypropylene resin of this embodiment can be found.

The above-mentioned intrinsic viscosity, which is also called a limiting viscosity number, is a yardstick which indicates the ability to enhance the viscosity of a solution of a polymer molecule. The intrinsic viscosity, especially, depends on a weight average molecular weight and a degree of branching of the resin. Accordingly, when a polymer having a long-chain branch is compared to a linear polymer with a weight average molecular weight the same as that of the polymer having a long-chain branch, the intrinsic viscosity serves as a yardstick indicating the degree of branching of the polymer. If two polymers have the same weight average molecular weight, the ratio of their intrinsic viscosities can be used as an index of degree of branching. The intrinsic viscosity of a polypropylene resin according to this embodiment can be measured by use of a measuring method disclosed by Elliot et al. in J. Appl. Polym. Sci., 14, 2947-2963 (1970). When using the above-mentioned measuring method, the intrinsic viscosity of a polypropylene resin according to this embodiment can be measured by use of a sample obtained by dissolving the polypropylene resin in tetralin or o-dichlorobenzene, for example, at 135° C. The aforementioned weight average molecular weight (Mw) can be measured by various methods. For example, especially preferably used is a method disclosed by M. L. McConnel in American Laboratory, May, 63-75 (1978), namely a low angle laser light scattering intensity measuring method.

To obtain (2) the polypropylene resin having a weight average molecular weight of 1×10⁵ or more, for example, a method described below can be used.

First, as a first step, polymerization of propylene is performed by continuously feeding liquid propylene at 57 kg/h, triethylaluminum at 1.3 mmole/h, t-butyl-n-propyldimethoxysilane at 0.13 mmole/h and a preliminarily activated solid catalyst component at 0.51 g/h under conditions including a polymerization temperature of 60° C. and a polymerization pressure of 27 kg/cm²G (gauge pressure). Through this operation is obtained a polymer with an intrinsic viscosity of 7.7 dl/g. The resulting polymer is transferred to a second stage without inactivation of the catalyst.

Next, as the second stage, a propylene polymerization is continued by feeding propylene and hydrogen so that the hydrogen concentration in the gas phase is held at 8 vol % and simultaneously feeding the catalyst-containing polymer transferred from the above-mentioned first stage, triethylaluminum at 60 mmole/h and t-butyl-n-propyldimethoxysilane at 6 mmole/h under conditions including a polymerization temperature of 80° C. and a polymerization pressure of 18 kg/cm²G. Through this operation, a polymer with an intrinsic viscosity of 7.7 dl/g is obtained.

The polypropylene resin obtained via the first and second stages has a weight average molecular weight of about 3.4×10⁵. The weight average molecular weight of the polypropylene resin can be controlled by the amounts of monomers for constituting the resin.

Incidentally, the resin material constituting the foamed layer may contain resins other than the first polypropylene resin. Specific examples of the other resins include homopolymers of olefins having not more than 6 carbon atoms such as ethylene, butene, pentene and hexene, or olefin copolymers obtained by copolymerizing two or more kinds of monomers selected from olefins having from 2 to 10 carbon atoms. The olefin copolymers may be any of block copolymers, random copolymers and graft copolymers. The olefin homopolymers and the olefin copolymers may be used singly or in combination of two or more of them.

Of the other resins mentioned above, particularly preferred are low-density polyethylene (LDPE), ultra low density polyethylene (ULDPE), linear low density polyethylene (LLDPE) and high density polyethylene (HDPE). It is preferable that the resin material constituting the foamed layer is blended with a small amount of polyethylene.

The aforementioned resin material may contain plasticizers, fillers or the like as long as the desired objects can be achieved. It is to be noted that a filler blended in a resin material used for forming a foamed layer may cause breakage of cells during production of a foamed sheet and therefore, in the present invention, the amount of a filler blended in a resin material used for forming a foamed layer should be determined carefully in consideration of melt viscosity of a resin used, a desired expansion ratio, and the like.

The foamed sheet of the present invention may have a plurality of foamed layers comprising a resin material containing the first polypropylene resin. When a plurality of foamed layers are present, the individual foamed layers may be composed of the same kind (composition) of polypropylene resin or may alternatively be composed of different kinds (composition) of polypropylene resins.

Next, a description about a non-foamed layer will be made below.

The foamed polypropylene resin sheet of the present invention has a non-foamed layer that satisfies the following requirements (i) and (ii):

(i) comprising a resin composition which contains a polypropylene resin and a filler and has a melt tension within the range of from 1 to 20 g, and

(ii) constituting one surface of the foamed polypropylene resin sheet.

The non-foamed layer, that is, essential non-foamed layer is a layer comprising a resin composition containing at least one kind of second polypropylene resin and a filler. The expansion ratio of the non-foamed layer is more preferably from 1.0 time to 1.5 times, inclusive, still more preferably from 1.0 time to 1.1 times, inclusive.

Specific examples of the second polypropylene resin include hompolymers of propylene and propylene-based copolymers containing not less than 50 mole % of propylene units. The second polypropylene resin may be a mixture of two or more kinds of resins. A resin the same as the first polypropylene resin may be used as the second polypropylene resin. In other words, the aforementioned foamed layer and the essential non-foamed layer may be composed of the same kind (composition) of polyproyplene resin or may alternatively be composed of different kinds (compositions) of polypropylene resins.

The foamed sheet of the present invention may have a plurality of essential non-foamed layers satisfying the above-mentioned requirements (i) and (ii). In other words, both surfaces of the foamed sheet of the present invention may be formed of non-foamed layers satisfying the requirement (i). When a plurality of essential non-foamed layers are present, the individual essential non-foamed layers may be composed of the same kind (composition) of polypropylene resin or may alternatively be composed of different kinds (compositions) of polypropylene resins.

Of the aforementioned second polypropylene resins, it is particularly preferable to use (3) a polypropylene resin having a melt flow rate (henceforth, referred to as MFR) within the range of from 0.5 to 5 g/10 minutes or (4) a long-chain branched polypropylene resin. The particulars of (4) the long-chain branched polypropylene resin are the same as those of the aforementioned long-chain branched polypropylene resin (1) and, therefore, detailed explanations are omitted here.

The polypropylene resin having a melt flow rate (MFR) within the range of from 0.5 to 5 g/10 minutes (3) may be any of a homopolymer, a block copolymer, a random copolymer and a graft copolymer.

The measurement of the melt flow rate (MFR) of the polypropylene resin is performed in accordance with JIS K7210. The MFR of the polypropylene resin is preferably within the range of from 0.5 to 5 g/10 minutes, more preferably within the range of from 1 to 3 g/10 minutes. Accordingly, when the MFR is set within the above-mentioned ranges, it is possible to reduce the draw-down during the vacuum forming to improve the formability.

Accordingly, as the second polypropylene resin, most preferable is a resin satisfying the requirements (4) to be a long-chain branched polypropylene and (3) to be a polypropylene resin having an MFR within the range of from 0.5 to 5 g/10 minutes.

Incidentally, the above-mentioned non-foamed layer contains a filler. As the filler, preferred are inorganic substances specific examples of which include inorganic fibers such as glass fibers and carbon fibers, inorganic particles such as talc, clay, silica and calcium carbonate. When the filler is talc, the average particle diameter of the talc is preferably within the range of from 0.1 to 50 μm.

The proportion of the filler contained in the essential non-foamed layer is preferably within the range of from 40 to 100 parts by weight, more preferably from 55 to 85 parts by weight based on 100 parts by weight of the second polypropylene resin. When the amount of the filler is within the above-mentioned ranges based on 100 parts by weight of the second polypropylene resin, a foamed sheet will have a sufficient rigidity when being heated to high temperatures and the foamed sheet is readily formable.

The resin composition constituting the essential non-foamed layer may contain, in addition to the second polypropylene resin and the filler, other resins. The particulars of the “other resins” are the same as those of the “other resins” which may be contained in the aforementioned foamed layer and therefore detailed explanations are omitted.

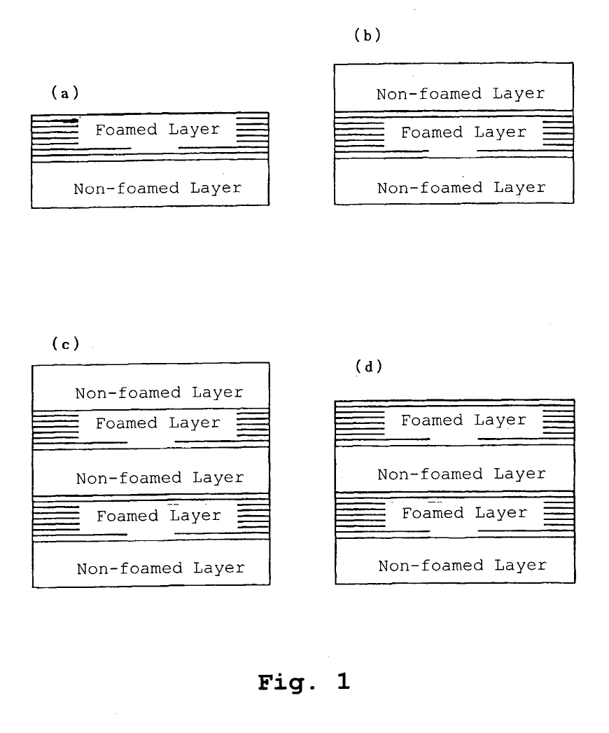

The foamed sheet of the present invention comprises at least one foamed layer and at least one essential non-foamed layer laminated together. At least one of the surfaces of the foamed sheet is an essential non-foamed layer. It is preferable that both surfaces of the foamed sheet are formed of essential non-foamed layers. When the foamed sheet has a plurality of the aforementioned foamed layers, a non-foamed layer which satisfies or do not satisfy the requirement (i) may be disposed between the aforementioned foamed layers. The mode of lamination in the foamed sheet include, as shown in FIG. 1, but is not particularly limited to, (a) a mode in which one foamed layer and one essential non-foamed layer are laminated, (b) a mode in which essential non-foamed layers form both surfaces of a foamed sheet and a foamed layer is disposed between the essential non-foamed layers, (c) a mode in which an essential non-foamed layer/a foamed layer/a non-foamed layer/a foamed layer/an essential non-foamed layer are laminated in this order from one side of a foamed sheet, and (d) a mode comprising a lamination of foamed sheet of the above-mentioned mode (a) in which one foamed layer and one essential non-foamed layer are laminated.

The essential non-foamed layer in the foamed sheet of the present invention contains a filler.

Furthermore, if a filler is incorporated in a foamed layer for the purpose of improving the flexural rigidity, the weight per unit area of the foamed sheet is to increase to a large extent. On the other hand, when a filler is incorporated not in a foamed layer but in a non-foamed layer, it is possible to improve the flexural rigidity without increasing the weight per unit area of the foamed sheet greatly. However, it is to be noted that, the foamed layer in the foamed sheet of the present invention may, as described previously, contain a filler as long as the desired objects of the present invention can be achieved.

In the foamed sheet of the present invention, the particle diameter of the filler dispersed in the second polypropylene resin of the essential non-foamed layer is preferably within the range of from 0.1 to 10 μm, more preferably within the range of from 1 to 5 μm. When the fillers have a particle diameter within the above-mentioned ranges, it is possible to obtain a foamed sheet excellent in flexural rigidity.

The particle diameter of the fillers dispersed in the second polypropylene resin can be determined by a method mentioned below.

A cut section of a foamed sheet along the thickness of the essential non-foamed layer is observed through a scanning electron microscope (SEM) at a magnification such that the fillers can be recognized clearly and, for 20 or more filler particles, the largest length of a particle is measured. The average of the measurements is used as the particle diameter of the fillers.

The thickness of the foamed sheet of the present invention is preferably within the range of from 0.1 to 3 mm. When the foamed sheet has a thickness within the range, the foamed sheet has a practically sufficient flexural rigidity and the foamed sheet can be produced easily.

The thickness of the foamed layer in the foamed sheet is preferably not less than 0.1 mm. In order to achieve a sufficient heat insulation property, the thickness of the foamed layer is more preferably not less than 0.3 mm. Furthermore, from the viewpoint of heat insulation property, the thicker the foamed layer of the foamed sheet the better.

On the other hand, the thickness of the essential non-foamed layer is not particularly limited as long as the smoothness of the surface of the foamed sheet, namely, the appearance of the foamed sheet is good, but it is preferably not less than 1 μm, more preferably not less than 10 am, and still more preferably not less than 50 μm. If the essential non-foamed layer is too thick, the light-weight property of the foamed sheet is impaired and the formability is also deteriorated.

The ratio of the thickness of the foamed layer to that of the essential non-foamed layer is preferably within the range of from 100:1 to 100:30, more preferably within the range of from 100:1 to 100:10, depending on the expansion ratios of the individual layers. When the ratio the thickness of the foamed layer to that of the essential non-foamed layer is within the ranges mentioned above, it is possible to reduce the basis weight of the foamed sheet and to provide a foamed sheet excellent in light-weight property, which is one of the merits of the foamed sheet of the present invention.

In the foamed sheet, the ratio with respect to weight per unit area, namely, with respect to basis weight, of the foamed layer to the essential non-foamed layer is preferably within the range of from 100:1 to 100:100, more preferably within the range of from 100:10 to 100:80. If the ratio with respect to basis weight is out of the lower limit, namely, if the ratio of the basis weight of the foamed layer to the basis weight of the essential non-foamed layer is greater than 100/1, the effect exhibited by the non-foamed layer is insufficient, whereas if the ratio with respect to basis weight is out of the upper limit, namely, if the ratio of the basis weight of the foamed layer to the basis weight of the essential non-foamed layer is less than 100/100, the basis weight of the sheet is too large and the light-weight property is adversely damaged. Therefore, by making the ratio with respect to basis weight within the above-mentioned range, it is possible to obtain a foamed sheet with good balance between rigidity and light-weight property.

In the present invention, when a plurality of foamed layers and/or a plurality of essential non-foamed layers are present, the aforementioned ratio with respect to basis weight indicates a ratio of the total basis weight of the foamed layers to the total basis weight of the essential non-foamed layers. In other words, when a plurality of foamed layers and a plurality of essential non-foamed surface layers are present, it is preferable that the ratio of the total basis weight of the foamed layers to the total basis weight of the essential non-foamed layers fall within the range of from 100:1 to 100:100, more preferably within the range of from 100:10 to 100:80. When a plurality of foamed layers are present but only a single essential non-foamed layer is present, it is preferable that the ratio of the total basis weight of the foamed layers to the basis weight of the essential non-foamed layer fall within the range of from 100:1 to 100:100, more preferably within the range of from 100:10 to 100:80.

When a foamed sheet contains a non-foamed layer which does not constitute a surface of the foamed sheet, it is preferable that the weight of the essential non-foamed layer(s) is within the range of from 10 to 30% by weight of the total weight of all the non-foamed layers contained in the foamed sheet. When the weight of the essential non-foamed layer(s) is within the above-mentioned range based on the total weight of all the non-foamed layers, it is possible to obtain a foamed sheet with better-balanced rigidity and light weight. Each of the “weight” and “total weight” used herein means a weight per unit area.

The foamed layer and the essential non-foamed layer, and a non-foamed layer other than the essential non-foamed layer may optionally contain plasticizers, colorants and the like.

In a foamed sheet of the present invention, the resin composition which contains the second polypropylene resin and constitutes a essential non-foamed layer forming the surface of the foamed sheet has a melt tension within the range of from 1 to 20 g. The method for measuring the melt tension will be described later.

The melt tension is preferably within the range of from 1 to 20 g, more preferably within the range of from 1 to 5 g. A melt tension of less than 1 g is undesirable because it causes an extremely large draw-down during vacuum forming; this results in generation of wrinkles in a formed article or causes such a trouble that a sheet comes into contact with a heater. On the other hand, a melt tension of greater than 20 g is also undesirable because the sheet will have a too great strength during its thermoforming and the formability of the sheet during its forming into the shape of a mold is extremely impaired. Accordingly, when the melt tension is within the above-mentioned ranges, it is possible to control the draw-down of a foamed sheet during its vacuum forming to improve the formability of the foamed sheet.

In the case of a foamed sheet in which a non-foamed layer is formed also in a portion besides the surfaces of the foamed sheet, for example, a foamed sheet having a plurality of foamed layers wherein a non-foamed layer is formed between the foamed layers and a foamed sheet in which a non-foamed not satisfying the requirement (i) is formed between a non-foamed layer and a foamed layer, it is most preferable that the resin compositions forming the individual non-foamed layers have a melt tension within the range of from 1 to 20 g.

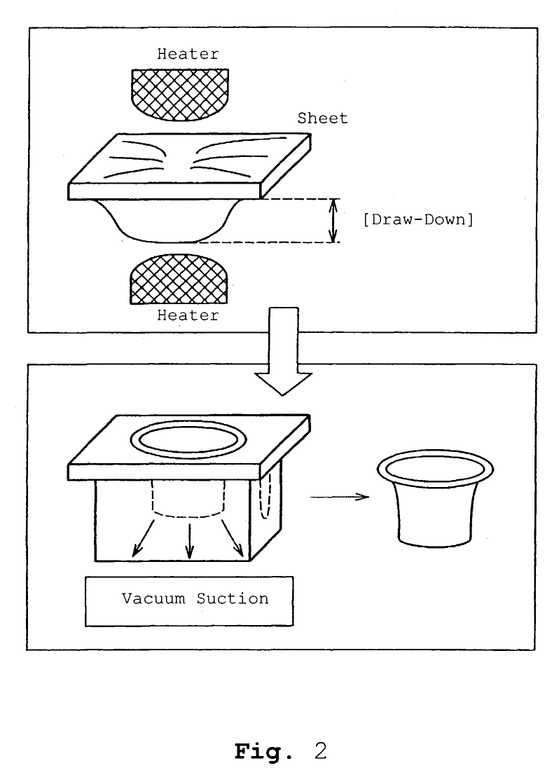

The draw-down is illustrated with reference to FIG. 2. When a foamed sheet is vacuum formed, it is necessary to carry out vacuum suction in order to form the foamed sheet into the shape of a mold. To perform the vacuum suction, the foamed sheet must be heated to soften. A foamed sheet the periphery of which is fixed is heated to sag in its central portion under its own weight.

When the sagging (draw-down) is great, the foamed sheet sags to a large extent. The sagging portion may come into contact with a heater for heating the foamed sheet to melt, or the foamed sheet may burn. Even if the sagging portion does not come into contact with the heater, wrinkles may appear in the flange portion of the foamed sheet; this may cause a poor appearance of a formed article.

On the other hand, when heating a foamed sheet sparingly in order to reduce the draw-down, defective forming may occur or a formed article is broken due to insufficient heating.

Accordingly, since the foamed sheet of the present invention has a surface which is constituted of a non-foamed layer comprising a resin composition having a melt tension within the range of from 1 to 20 g, draw-down hardly occurs even when the foamed sheet is fully heated. Therefore, the foamed sheet of the present invention is superior in thermoformability. In addition, the foamed sheet of the present invention is prevented from melting or burning from action of a heater for heating. Therefore, the foamed sheet can be formed more safely.

The foamed sheet of the present invention may optionally have an additional foamed or non-foamed layer comprising a thermoplastic resin in addition to the above-mentioned foamed layer and the essential non-foamed layer. Specifically, for example, oriented polypropylene films (OPP), non-oriented polypropylene films (CPP), layers comprising saponified ethylene-vinyl ester copolymer, and the like are particularly preferably employed as the layer comprising a thermoplastic resin.

Moreover, so-called modified resins, which are obtained by graft modification, crosslinking or molecular-chain-terminal-modification of the above-mentioned thermoplastic resin, can also be employed.

As the above-mentioned additional layer, that having a laminate structure comprising two or more layers is used particularly preferably. When the additional layer comprises a single layer, it preferably has a thickness within the range of from 10 to 100 μm. When it is a layer comprising multiple layers, the total thickness of the layers is preferably within the range of from 50 to 200 μm.

When the additional layer has a laminate structure comprising two or more layers, an adhesive resin layer may also be formed. Specific examples of the resin constituting the adhesive resin include polypropylene resins modified with unsaturated carboxylic acids, such as maleic acid, or their anhydrides.

Examples of the layer composition of a composite foamed sheet obtained by forming two or more additional layers while laminating them in the aforementioned foamed sheet include a layer composition of non-oriented polypropylene layer/adhesive resin layer/saponified ethylene-vinyl ester copolymer/adhesive resin layer/non-foamed layer/foamed layer/essential non-foamed layer, and a layer composition of non-oriented polypropylene layer/adhesive resin layer/saponified ethylene-vinyl ester copolymer/adhesive resin layer/non-foamed layer/foamed layer/non-foamed layer/non-foamed layer/foamed layer/essential non-foamed layer. When composite foamed sheets of the above-mentioned layer compositions are formed into containers for cooking in a microwave oven, it is recommended to form the sheets so that the inside surfaces of the containers are formed of non-oriented polypropylene layers such as those mentioned above.

Examples of a method for manufacturing the above-mentioned composite foamed sheets include extrusion lamination, sandwich lamination in which a thermoplastic resin is melt extruded between a sheet or film of another thermoplastic resin and a foamed sheet to laminate them, and a method in which comprising melting a surface of at least one of a sheet or film of a thermoplastic resin and a foamed sheet by heating with hot air or an infrared heater and then laminating them.

As a method for the lamination, particularly preferred from the viewpoints of light-weight property and cost of composite foamed sheets is a thermal lamination method which comprises passing a foamed sheet and a thermoplastic resin layer through nip rolls which comprises two or more rolls and applying hot air to the nip portion from an air knife or the like to melt a surface or surfaces of at least one of the foamed sheet and the thermoplastic resin layer, and pressing the foamed sheet and the thermoplastic resin layer to laminate them together.

The foamed sheet of the present invention may further contain additives, specific examples of which include nucleating agents, antioxidants, light stabilizers, ultraviolet absorbers, anti-clouding agents, anti-fogging agents, plasticizers, antistatic agents, lubricants, colorants, dioxin inhibitors, ethylene gas absorbers, deodorants, freshness-keeping agents and antibacterial agents. Such listed additives may be incorporated in a foamed layer of a non-foamed layer unless the effect of the present invention is affected. In particular, incorporation of a nucleating agent such as organophosphates in an essential non-foamed layer (skin layer) or other non-foamed layer can accelerate the rate of crystal formation, reducing the draw-down.

The method for manufacturing the foamed sheet of the present invention is not particularly restricted. Preferably employed is a method comprising extruding a molten resin through a die such as a flat die (e.g. a T die and a coat hunger die), a straight die, a circular die (e.g. a cross head die) and stretching it while foaming. Alternatively, a method comprising extruding a molten resin through a die to foam and then stretching it is also preferable.

When the foamed sheet of the present invention is shaped, a foamed polypropylene resin container for cooking in a microwave oven and the like can be produced. An example of a shaping method by which the above-mentioned foamed sheet is shaped, for example, into a foamed polypropylene resin container for cooking in a microwave oven includes a method comprising softening a foamed sheet from which the container is to be formed by heating with an infrared heater or the like, subsequently shaping the foamed sheet by vacuum forming, pressure forming, vacuum/pressure forming or the like by use of a die such as a male die, a female die, or paired male and female dies, and then cooling the shaped sheet to harden it. In this shaping method, it is also possible to perform preliminary shaping into a container form by bringing a plug having a configuration similar to that of the container into contact with the foamed sheet before or after the shaping of the foamed sheet by vacuum forming or pressure forming by use of one die selected from a male die and a female die.

Moreover, the foamed sheet of the present invention may further have a heat seal layer. When a foamed sheet having a heat seal layer is shaped into a container, it is preferable to dispose the heat seal layer so as to form the innermost layer of the container. It is preferable that the heat seal layer be a layer which can be heat sealed to a lid and can be sealed with the lid at an appropriate adhesiveness (peel strength), in other words, can be separated from the lid easily by hand but does separate from the lid even at high temperatures from about 120 to 140° C. unless power is applied artificially. An example of a heat seal layer having such properties includes a layer comprising a resin composition containing 100 parts by weight of a thermoplastic resin and from 0.5 to 160 parts by weight of fine particles having an average particle size of from 0.05 to 20 μn selected from the group consisting of organic fine particles and inorganic fine particles. The thermoplastic resin used herein is preferably a resin comprising 100 parts by weight of a polypropylene resin and from 10 to 100 parts by weight of a polyethylene resin.

In addition, a foamed polypropylene sheet according to the present invention may be a foamed polypropylene sheet having at least one foamed layer comprising a resin material containing a polypropylene resin, with the proviso that when there are two or more foamed layers it is not necessary that all the foamed layers contain the same polypropylene resin, and having such a constitution that at least one surface of the foamed polypropylene resin layer has thereon a non-foamed layer comprising a resin composition with a melt tension ranging from 1 to 20 g containing a polypropylene resin and a filler and the ratio of the total basis weight of all the foamed layer or layers contained in the foamed polypropylene resin sheet to the basis weight of the non-foamed layer is within the range of from 100:1 to 100:100.

Furthermore, a foamed polypropylene sheet according to the present invention may be a foamed polypropylene sheet having at least one foamed layer comprising a resin material containing a polypropylene resin, with the proviso that when there are two or more foamed layers it is not necessary that all the foamed layers contain the same polypropylene resin, and having such a constitution that both surfaces of the non-foamed layer each have thereon a non-foamed layer comprising a resin composition with a melt tension ranging from 1 to 20 g containing a polypropylene resin and a filler, provided that both non-foamed layers may contain the same polypropylene resin or different polypropylene resins and that both non-foamed layer may contain the same filler or different fillers, and the ratio of the total basis weight of all the foamed layer or layers contained in the foamed polypropylene resin sheet to the total basis weight of the non-foamed layers is within the range of from 100:1 to 100:100.

### EXAMPLES

The present invention will be described in more detail by reference to Examples and Comparative Examples, but the invention is not restricted to them.

### Example 1

A foamed polypropylene resin sheet comprising a two-kind three-layer structure, essential non-foamed layer/foamed layer/essential non-foamed layer, was prepared by the method shown below.

(Material for Constituting Foamed Layer)

As a material for constituting a foamed layer, used was a mixture obtained by pellet blending a polypropylene polymerized by two-stage polymerization and a polyethylene in a weight ratio of 70/30. The methods for the preparation of the polypropylene and the material for constituting a foamed layer are described below.

(1) Synthesis of Solid Catalyst

After a 200-L stainless steel reactor equipped with a stirrer was purged with nitrogen, 80 L of hexane, 6.55 mol of tetrabutoxytitanium, 2.8 mol of diisobutyl phthalate and 98.9 mol of tetraethoxysilane were fed into the reactor to obtain a homogeneous solution. Then, 51 L of a 2.1 mol/L solution of butylmagnesium chloride in diisobutyl ether was dropped slowly over 5 hours while maintaining the temperature within the reactor at 5° C. After the completion of the dropping, the mixture was stirred further for 1 hour at room temperature and was subjected to solid-liquid separation at room temperature, followed by a three-time repetition of washing with 70 L of toluene. Next, after such an addition of toluene that the slurry concentration become 0.6 kg/L, a mixed solution of 8.9 mol of n-butyl ether and 274 mol of titanium tetrachloride was added and then 20.8 mol of phthaloyl chloride was added, followed by a reaction at 110° C. for 3 hours. After the completion of the reaction, the reaction mixture was washed twice with toluene at 95° C. Subsequently, following adjustment of the slurry concentration to 0.6 kg/L, 3.13 mol of diisobutyl phthalate, 8.9 mol of di-n-butyl ether and 137 mol of titanium tetrachloride were added, followed by a reaction at 105° C. for 1 hour. After the completion of the reaction, so id-liquid separation was performed at the same temperature, followed by two-time washing with 90 L of toluene at 95° C. Following adjustment of the slurry concentration to 0.6 kg/L, 8.9 mol of di-n-butyl ether and 137 mol of titanium tetrachloride were added, followed by a reaction at 95° C. for 1 hour. After the completion of the reaction, solid-liquid separation was performed at the same temperature, followed by three-time washing with 90 L of toluene. Following adjustment of the slurry concentration to 0.6 kg/L, subsequently, 8.9 mol of di-n-butyl ether and 137 mol of titanium tetrachloride were added, followed by a reaction at 95° C. for 1 hour. After the completion of the reaction, solid-liquid separation was performed at the same temperature, followed by three-time washing with 90 L of toluene and subsequent three-time washing with 90 L of hexane. After drying under reduced pressure, 11.0 kg of a solid catalyst component was obtained.

The solid catalyst component contained 1.9% by weight of titanium atom, 20% by weight of magnesium atom, 8.6% by weight of phthalate, 0.05% by weight of ethoxy group, and 0.21% by weight of butoxy group. Further, the solid catalyst component showed favorable particle properties free from fine powder.

(2) Preliminary Activation of Solid Catalyst Component

Into a 3-L capacity of stainless steel autoclave equipped with a stirrer, 1.5 L of fully dewatered and degassed n-hexane, 37.5 mmol of triethylaluminum, 3.75 mmol of t-butyl-n-propyldimethoxysilane and 15 g of the above-mentioned solid catalyst component were added. Preliminary activation was performed by continuously feeding 15 g of propylene over 30 minutes while maintaining the temperature in the autoclave within the range of from 5 to 15° C.

(3) Polymerization of Propylene-Based Polymer

First Stage

In a 300-L capacity of stainless steel polymerization vessel (first polymerization vessel), while feeding liquid propylene at a rate of 57 kg/h so as to maintain a polymerization temperature of 60° C. and a polymerization pressure of 27 kg/cm²G (gauge pressure), 1.3 mmole/h of triethylaluminum, 0.13 mmole/h of t-butyl-n-propyldimethoxysilane and 0.51 g/h of the preliminarily activated solid catalyst component were fed continuously to perform propylene polymerization substantially in the absence of hydrogen, obtaining 2.0 kg/h of polymer. The amount of the polymer formed per gram of the catalyst was 3920 g. A part of the polymer formed was sampled and analyzed. It was found that the polymer had an intrinsic viscosity of 7.7 dL/g. The resulting polymer was transferred continuously to a second polymerization vessel without performing deactivation.

Second Stage

In a 1-m³ capacity of fluidized bed reactor (second polymerization vessel) equipped with a stirrer, 18.2 kg/h of polymer was obtained through continuous propylene polymerization performed by feeding the catalyst-containing polymer transferred from the first polymerization vessel of the first stage, 60 mmole/h of triethylaluminum and 6 mmole/h of t-butyl-n-propyldimethoxysilane while feeding propylene so as to maintain a polymerization temperature of 80° C., a polymerization pressure of 18 kg/cm 2G and a hydrogen concentration in the gas phase of 8 vol %. The polymer had an intrinsic viscosity of 1.9 dL/g.

The amount of the polymer formed in the second stage per gram of the catalyst was 31760 g. The polymerization weight ratio of the first polymerization vessel to the second polymerization vessel was 11/89. The polymer formed in the polymerization reaction of the second stage had an intrinsic viscosity of 1.9 dL/g.

(4) Pelletization of Polymer

Pellets of polypropylene having a melt flow rate (MFR) of 12 g/10 minutes (230° C., 21.168 N (2.16 kgf)) was obtained by adding 0.1 part by weight of calcium stearate, 0.05 part by weight of a phenol type antioxidant (available as Irganox 1010 available from Ciba Specialty Chemicals) and 0.2 part by weight of another phenol type antioxidant (available as Sumilizer BHT available from Sumitomo Chemical Co., Ltd.) to 100 parts by weight of a powder of the polymer obtained through the above-mentioned two-stage reaction, mixing and melt kneading them at 230° C.

(5) Blending of Material for Constituting Foamed Layer

A mixture obtained by dry blending in a weight ratio of 70/30 the polypropylene obtained by the method described above with pellets of a polyethylene (available as Sumikathene G201 available from Sumitomo Chemical Co., Ltd., MFR 2 g/10 minutes (190° C., 21.168 N (2.16 kgf), density 0.919 g/cm³) was used as a material for constituting a foamed layer.

(Material for Constituting Non-Foamed Layer)

A resin composition obtained by dry blending a polypropylene (Polypropylene AH161C available from Sumitomo Chemical Co., Ltd., MFR 3 g/10 minutes (230° C., 21.168 N (2.16 kgf)) and talc (available as MicronWhite #5000S available from Hayashi Chemical Industry Co., Ltd., main ingredient: magnesium silicate, average particle diameter 2.8 μm) in a weight ratio of 60/40, followed by granulation with a co-rotating twin screw extruder (available as Ikegai PCM45 available from Ikegai Corp., 45 mm+, L/D30) at a rotation speed of 200 rpm and a die temperature of 240° C. and drying.

(Extrusion Foaming)

An apparatus was used in which a 50-mmφ twin screw extruder and a 32-mmφ single screw extruder each equipped with a 90-mmφ circular die was used. A raw material obtained by blending 1 part by weight of a nucleating agent (available as HYDROCEROL available from Boehringer Ingelheim Chemicals) to 100 parts by weight of the above-mentioned material for constituting a foamed layer was fed into a hopper of the 50-mmφ twin screw extruder and 1 part by weight of carbon dioxide gas was injected at a position where the material was fully molten. The raw material and the carbon dioxide gas were fully melt kneaded and transferred into a die. The molten mixture to become a foamed layer and a material for constituting a non-foamed layer to become a non-foamed layer transferred into the 32-mmφ single screw extruder were laminated in the die and extruded. The extrudate was cooled on a 210-mmφ mandrel placed right behind and stretched to 2.3 times to afford a cylindrical foamed sheet. Subsequently, the cylindrical foamed sheet was slit with a cutter and was spread to form a planar foamed sheet, which was taken up by a winder to yield a foamed polypropylene resin sheet of the present invention.

### Example 2

A foamed polypropylene resin sheet was obtained in the same manner as EXAMPLE 1, except that used as a material for constituting a non-foamed layer was a resin composition obtained by dry blending a polypropylene (polypropylene available as PF814 available from Montell Technology Company, MFR 2 g/10 minutes (230° C., 21.168 N (2.16 kgf)) and talc (available as MicronWhite #5000S available from Hayashi Chemical Industry Co., Ltd., main ingredient: magnesium silicate, average particle diameter 2.8 μm) in a weight ratio of 60/40, followed by granulation with a co-rotating twin screw extruder (available as Ikegai PCM45 available from Ikegai Corp., 45 mmφ, L/D 30) at a rotation speed of 200 rpm and a die temperature of 240° C. and drying.

### Comparative Example 1

A foamed polypropylene resin sheet was obtained in the same manner as EXAMPLE 1, except that used as a material for constituting a non-foamed layer was a resin composition obtained by dry blending a polypropylene (polypropylene available as AW161C available from Sumitomo Chemical Co., Ltd., MFR 8 g/10 minutes (230° C., 21.168 N (2.16 kgf)) and talc (available as MicronWhite#5000S available from Hayashi Chemical Industry Co., Ltd., main ingredient: magnesium silicate, average particle diameter 2.8 μm) in a weight ratio of 60/40, followed by granulation with a co-rotating twin screw extruder (available as Ikegai PCM45 available from Ikegai Corp., 45 mmφ, L/E 30) at a rotation speed of 200 rpm and a die temperature of 240° C. and drying.

(Evaluation)

The foamed polypropylene resin sheets obtained in EXAMPLES and COMPARATIVE EXAMPLE were evaluated for melt tension, MFR, draw-down property and appearance of formed articles. Evaluation methods are described concretely below.

(Measurement of Melt Tension)

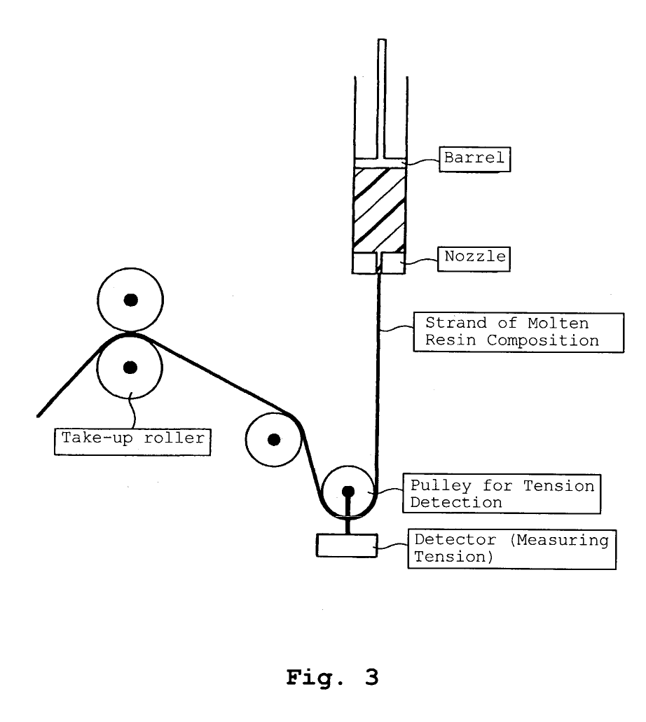

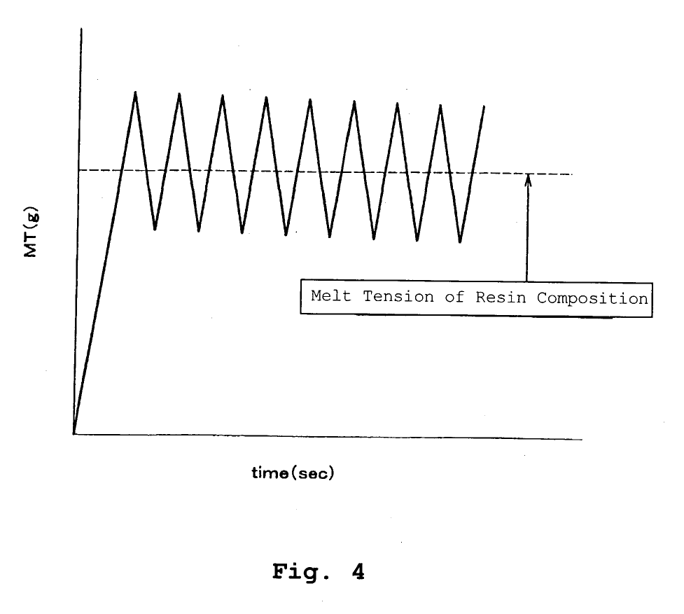

The measurement of the melt tension of a resin composition constituting a non-foamed layer of a surface was performed, as shown in FIG. 3, by use of a capirometer (Capirograph available from Toyo Seiki Seisaku-sho, Ltd.) having a barrel (cylinder) 350 mm in length and 9.55 mm in diameter and a nozzle 20 mm in length and 1 mm in inner diameter mounted to the front end of the barrel. A resin composition to be measured was filled in the barrel, into which a piston was then inserted, and was preliminary heated at 230° C. Eight minutes after the commencement of the heating, after it was confirmed that the resin was molten completely and became capable of being extruded without containing bubbles, the resin was extruded at a piston speed of 10 mm/min into a strand through a small through hole of the nozzle mounted at the front end of the barrel. The extruded strand-shaped resin was hanged on a pulley for detection of tension (diameter 45 mm) and was taken up around a take-up roller (diameter 50 mm) at a 10 m/min. The melt tension of the strand-shaped resin detected by a detector linked to the pulley for detection of tension was measured with time. As illustrated in FIG. 4, a graph in which the ordinate indicates melt tension and the abscissa indicates time was obtained. The above-described measurement was repeated three times or more. The average of the mean values of amplitude of melt tension in the region where the amplitude of melt tension is stabilized in the individual graphs was used the melt tension of the resin. The results are shown in Table 1.

(Melt Flow Rate (MFR) of Resin)

The measurement of the melt flow rate of a resin was carried out according to JIS K7210.

Measurement was carried out with a commercially available melt indexer (Melt Indexer Model L207 available from Takara Industries) using a barrel 160 mm in length and 9.55 mm in diameter; a die 8 mm in length, 9.5 mm in outer diameter and 2.1 mm in inner diameter; and a piston having a head 6.35 mm in length and 9.47 mm in diameter.

First, a resin composition to be measured was filled in the barrel and then the piston was inserted into the cylinder. A weight of 2.16 kg was placed on the piston and preliminary heating was performed at an appropriate temperature: 230° C. for polypropylene and 190° C. for polyethylene. Six minutes after the commencement of the heating, after it was confirmed that the resin was molten completely and became capable of being extruded without containing bubbles, an extrudate extruded through the outlet of the die in an early stage of the extrusion was removed and then the weight of the resin extruded after the removal and the time elapsed for the extrusion were measured. The amount of a resin extruded per 10 minutes was calculated. In the case of a resin having a melt flow rate of approximately from 3.5 to 10 g/10 minutes, it is recommended to fill approximately from 5 to 8 g of resin in a cylinder and measure the extrusion amount for about 30 seconds. The measurement was repeated three times or more and the average of the measurements was used as the melt flow rate of the resin. The results are shown in Table 1.

(Thermoformability (Draw-Down))

For the measurement of draw-down, the foamed polypropylene resin sheets obtained in EXAMPLES and COMPARATIVE EXAMPLE, sized 1000 mm×1000 mm, were used. A foamed sheet was fixed by applying thereto a square metallic clipping member having an external dimension of 1050 mm×1050 mm and having inside a hole of 950 mm×950 mm, from the top and the bottom of the foamed sheet.

Next, two infrared heaters sized 1100 mm×1100 mm were placed at the positions 30 cm away from the surfaces (the top and the bottom) of the sheet. The foamed sheet was heated so that the temperature of the top surface of the sheet became 150° C. while setting the upper infrared heater at 400° C. and the lower infrared heater at 350° C.

When the temperature of the top surface of the sheet reached 150° C., the infrared heaters were removed and the size of sagging in the central portion from the position of the clipping member was measured with a scale; the size of the sagging was used as the magnitude of draw-down. The results are shown in Table 1.

(Appearance of Formed Article)

For evaluating the appearance of a formed article, a container comprising a foamed polypropylene resin sheet was prepared by vacuum forming. The forming method by vacuum forming is described below.

The foamed polypropylene resin sheets obtained in EXAMPLES and COMPARATIVE EXAMPLE were vacuum formed using a vacuum forming machine. First, a foamed sheet was clipped with a clip member and both (top and bottom) surfaces of the foamed sheet were heated with infrared heaters so that the temperatures of the surfaces of the foamed sheet became 150° C. When the temperatures of the surfaces of the foamed sheet became 150° C., the infrared heaters were removed. A plug was then moved towards the sheet and brought into contact with the foamed sheet. Subsequently, the plug was moved vertically to the surface of the foamed sheet clipped with the clipping member so that the foamed sheet was brought into contact with a female mold, thereby preliminarily forming the foamed sheet into a shape of a container. Next, the foamed sheet was attached to the female mold firmly by vacuum suction from the female mold, thereby being formed into the same shape as the female mold.

After that, the container formed was air-cooled using a fan to harden. The foamed sheet with the shape of a container was released from the fixing by the clipping member and was removed from the female mold. When the edge of the foamed sheet was trimmed, a container comprising a foamed polypropylene resin sheet (diameter of opening=130 mm, width of flange=10 mm, diameter of bottom=60 mm, height=50 mm).

The condition of wrinkles in a flange portion of a cup-shaped container obtained was evaluated visually. The results of the evaluation are indicated by symbols “o” for the case where almost no wrinkles were found in a flange of a container and “x” for the case where many wrinkles were found in a flange of a container. The results are shown in Table 1.

TABLE 1

| | | | COMPARATIVE |
|---|---|---|---|
| | EXAMPLE 1 | EXAMPLE 2 | EXAMPLE 1 |
| Thickness of | 1.0 | 1.0 | 1.0 |
| foamed sheet (mm) | | | |
| Thickness of | 0.92 | 0.92 | 0.92 |
| foamed layer (mm) | | | |
| Thickness of | 0.04 | 0.04 | 0.04 |
| non-foamed | | | |
| layer (mm) | | | |
| Expansion ratio of | 4.5 | 4.5 | 4.5 |
| foamed layer (times) | | | |
| Expansion ratio of | 1.0 | 1.0 | 1.0 |
| essential non- | | | |
| foamed layer (times) | | | |
| Amount of talc in | 67 | 67 | 67 |
| non-foamed layer | | | |
| (parts by weight) | | | |
| (based on 100 parts | | | |
| by weight of | | | |
| second poly- | | | |
| propylene resin | | | |
| composition) | | | |
| Non-foamed layer | 50 | 50 | 50 |
| (parts by weight) | | | |
| (based 100 parts | | | |
| by weight of foamed | | | |
| layer) | | | |
| MFR of resin | 3 | 2 | 8 |
| composition in | | | |
| non-foamed layer | | | |
| (g/10 min) | | | |
| Melt tension of | 1.1 | 4.1 | 0.6 |
| second poly- | | | |
| propylene resin | | | |
| composition (g) | | | |
| Thermoformability | 11 | 8 | 19 |
| (Draw-down | | | |
| property) (cm) | | | |
| Appearance of | o | o | x |
| formed article | | | |

The results above show that when the melt tension of a resin composition constituting a non-foamed layer is brought within the range of from 1 to 20 g, draw-down of a foamed polypropylene resin sheet to be obtained can be controlled. Therefore, when a formed article is produced from a foamed polypropylene resin sheet of the present invention, no wrinkles are formed in a flange of the formed article and the formed article has a good appearance. In addition, since draw-down can be controlled when the melt tension is brought within the range of from 1 to 20 g, there is no possibility that a foamed polypropylene resin sheet will come into contact with a heater for heating the sheet during the production of a formed article by vacuum forming. Therefore, formed articles can be produced more safely.

The foamed polypropylene resin sheet of the present invention is, as described above, a foamed polypropylene resin sheet having a foamed layer comprising a resin material containing a polypropylene resin, wherein the foamed polypropylene resin sheet has a non-foamed layer (essential non-foamed layer) satisfying the following requirements (i) and (i):

(i) comprising a resin composition which contains a polypropylene resin and a filler and has a melt tension within the range of from 1 to 20 g, and

(ii) constituting one surface of the foamed polypropylene resin sheet,

wherein the ratio of the basis weight of the foamed layer to the basis weight of the non-foamed layer falls within the range of from 100:1 to 100:100.

Since the resin composition constituting the essential non-foamed layer has a melt tension within the range of from 1 to 20 g, it is possible to inhibit occurrence of the draw-down of a foamed polypropylene resin sheet to be obtained. This results, when a formed article is produced by using the foamed polypropylene resin sheet, in an effect of rendering the appearance of the formed article because no wrinkles are formed in a flange portion of the formed article. In addition, since the occurrence of draw-down can be controlled by setting the melt tension within the range of form 1 to 20 g, the foamed polypropylene resin sheet never comes in contact with a heater for heating it through its draw-down. Therefore, the foamed polypropylene resin sheet is prevented from melting or burning. Accordingly, an effect such that a formed article can be produced a formed article using therein a foamed polypropylene resin sheet is achieved.

The foamed polypropylene resin sheet of the present invention more preferably has a constitution in which the essential non-foamed layer contains a filler in an amount within the range of from 40 to 100 parts by weight based on 100 parts by weight of the second polypropylene resin.

The foamed polypropylene resin sheet of the present invention more preferably has a constitution in which the resin composition constituting the essential non-foamed layer has a melt flow rate of from 0.5 to 5 g/10 minutes.

The foamed polypropylene resin sheet of the present invention more preferably has a constitution in which both surfaces of the foamed polypropylene resin sheet are essential non-foamed layers satisfying the above-mentioned requirement (i).

According to the foregoing constitution, making both surfaces be essential non-foamed layers satisfying the above-mentioned requirement (i) achieves an effect of controlling the draw-down more effectively.

What is claimed is:

1. A foamed polypropylene resin sheet having a foamed layer comprising a resin material containing a polypropylene resin, wherein the foamed polypropylene resin sheet has a non-foamed layer satisfying the following requirements (i) and (ii):
(i) comprising a resin composition which contains a polypropylene resin and a filler and has a melt tension within the range of from 1 to 20 g, and
(ii) constituting one surface of the foamed polypropylene resin sheet,
wherein the ratio of the basis weight of the foamed layer contained in the foamed polypropylene resin sheet to the basis weight of the non-foamed layer constituting the at least one surface of the foamed polypropylene resin sheet falls within the range of from 100:1 to 100:100.

2. The foamed polypropylene resin sheet according to claim 1, wherein the non-foamed layer contains a filler in an amount within the range of from 40 to 100 parts by weight based on 100 parts by weight of the polypropylene resin contained in the resin composition.

3. The foamed polypropylene resin sheet according to claim 1 or 2, wherein the resin composition constituting the non-foamed layer has a melt flow rate within the range of from 0.5 to 5 g/10 minutes.

4. The foamed polypropylene resin sheet according to claim 1, wherein both surfaces of the foamed polypropylene resin sheet are constituted of non-foamed layers satisfying said requirement (i).
